(19) United States
(12) Patent Application Publication
(10) Pub. No.: US 2003/0083996 A1
(43) Pub. Date: May 1, 2003

(54) Secure remote printing via a communication network

(76) Inventor: Todd Fischer, Boise, ID (US)

Correspondence Address: HEWLETT-PACKARD COMPANY, Intellectual Property Administration, P.O. Box 272400, Fort Collins, CO, 80527-2400, US

(21) Appl. No.: 10/053,375

(22) Filed: Oct. 25, 2001

(51) Int. Cl. H04K 1/00; H04L 9/00; G06F 17/60

(52) U.S. Cl. 705/52

(57) ABSTRACT

Secure printing systems are provided. A representative secure printing system includes a remote print system that is configured to provide a user with an encryption key. The remote printing system also is configured to receive information encrypted using the encryption key, decrypt the information with a corresponding decryption key, and enable the information, once decrypted, to be printed. Methods and other systems also are provided.

### BACKGROUND OF THE INVENTION

1. Field of the Invention

The present invention generally relates to printing. In particular, the invention relates to systems and methods for remote printing that facilitate secure transmission of data via a communication network.

2. Description of the Related Art

In order for a user to have access to printed documents when remote from their computer network, such as when traveling, a user typically exercises one of limited options. As a first option, the user could print the required documents before departing on a trip and physically carry the printed documents to the location where the documents are needed. As a second option, the user could carry a laptop, for example, which can store information that the user may require to be printed. The user also could carry a printer so that the required documents can be generated at the location where they are needed. As is known, however, the added encumbrance of carrying printed documents or, alternatively, a computer and an associated printer may, at best, be inconvenient.

Another option potentially exercised by a user involves remotely accessing the user's computer network. Once accessed, the user could retrieve information from the network and print the information at the remote location. This alternative, however, typically involves transmitting information via a communication network in an non-secure format and, thus, may be an undesirable alternative. Therefore, it should be appreciated that there is a need for improved systems and methods that address these and/or other shortcomings of the prior art.

### SUMMARY OF THE INVENTION

Briefly described, the present invention involves remote printing of information that is provided to the remote location via secure transmission. In this regard, methods for secure printing of information transmitted via a communication network are provided. Typically, the information to be printed is stored in memory at a first location that is remote from a user. Additionally, the information usually is accessible to the user via the communication network.

A representative method includes: enabling an encryption key to be received at a second location remote from the first location; enabling information that is to be printed to be identified; and enabling the encryption key and information corresponding to the information that is to be printed to be transmitted to the first location via the communication network. In this manner, the information that is to be printed can be encrypted using the encryption key, transmitted to the second location via the communication network, decrypted using a corresponding decryption key, and printed.

Secure printing systems also are provided. In this regard, a representative secure printing system includes a remote print system that is configured to provide a user with an encryption key. The remote printing system also is configured to receive information encrypted using the encryption key, decrypt the information with a corresponding decryption key, and enable the information, once decrypted, to be printed.

Another secure printing system is adapted for printing information that is stored in memory at a location remote from a user. Typically, the information is accessible to the user via a communication network. Such a secure printing system includes a remote print system arranged at a location remote from the information. The remote print system is configured to provide a user with an encryption key, communicate with the communication network, and receive information encrypted using the encryption key. The remote print system is also configured to decrypt the information with a corresponding decryption key and enable the information, once decrypted, to be printed.

Other features of the present invention will become apparent to one with skill in the art upon examination of the following drawings and detailed description. It is intended that all such features be included herein within the scope of the present invention, as defined in the appended claims.

### BRIEF DESCRIPTION OF THE SEVERAL VIEWS OF THE DRAWINGS

The present invention, as defined in the claims, can be better understood with reference to the following drawings. The drawings are not necessarily to scale, emphasis instead being placed on clearly illustrating the principles of the present invention.

FIG. 1 is a schematic diagram depicting a representative embodiment of the secure printing system of the present invention.

FIG. 2 is a schematic diagram depicting a computer or processor-based device that may be utilized to implement a representative embodiment of the remote print system of FIG. 1.

FIG. 3 is a flowchart depicting functionality of a representative embodiment of the remote print system of FIG. 2.

FIG. 4 is a flowchart depicting functionality of another representative embodiment of the remote print system of FIG. 2.

FIG. 5 is a schematic diagram depicting a computer or processor-based device that may be utilized to implement a representative embodiment of the data retrieval/encryption system of FIG. 1.

FIG. 6 is a flowchart depicting functionality of a representative embodiment of the data retrieval/encryption system of FIG. 4.

FIG. 7 is a flowchart depicting functionality of another representative embodiment of the data retrieval/encryption system of FIG. 4.

FIG. 8 is a schematic diagram depicting a computer or processor-based device that may be utilized to implement a representative embodiment of the print request system of FIG. 1.

FIG. 9 is a flowchart depicting functionality of a representative embodiment of the print request system of FIG. 8.

### DETAILED DESCRIPTION

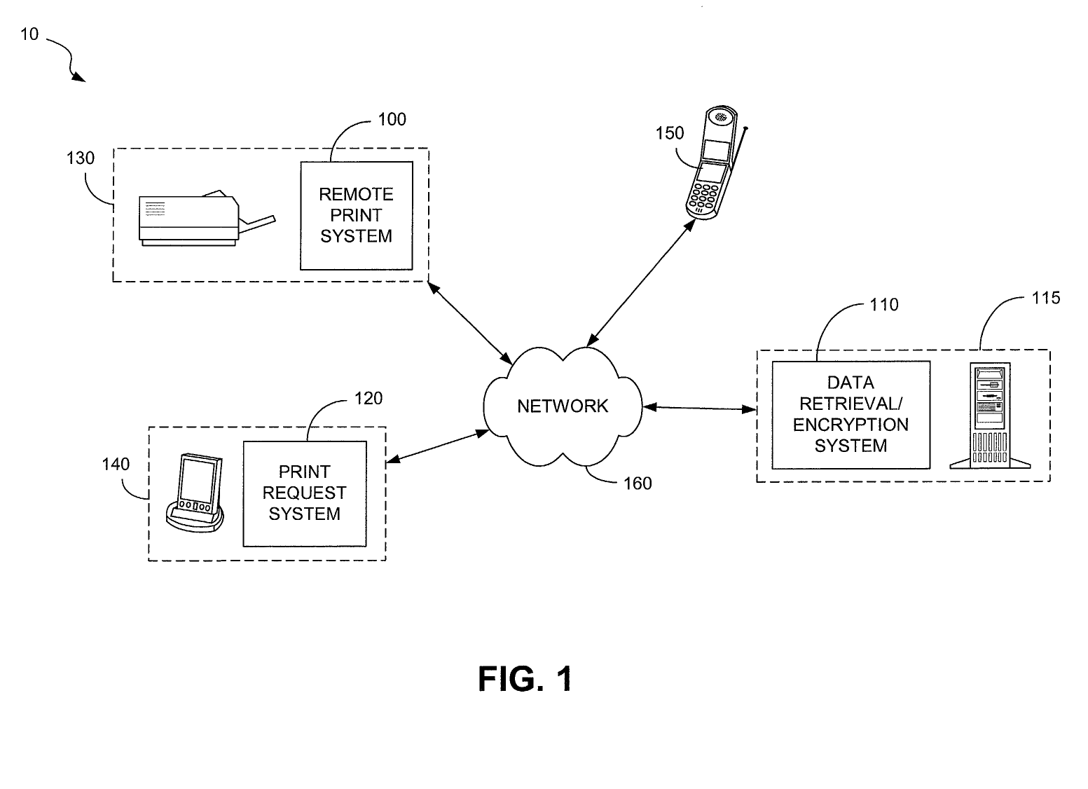

Referring now to the figures, wherein like reference numerals indicate corresponding components throughout the several views, FIG. 1 depicts a representative embodiment of a secure printing system 10 of the present invention. As described in greater detail herein, the secure printing system is adapted to provide a user with printed information. Typically, embodiments of the secure printing system are able to provide the printed information to a user at a location remote from the user's computer network. In particular, the secure printing systems are able to provide the printed information to a user at a location remote from the location at which corresponding information is stored in memory. Preferably, the information used to create the printed information is transmitted via a communication network in a secure format so that it is difficult for another party to intercept and/or use the transmitted information.

As shown in FIG. 1, secure printing system 10 can include one or more of a remote print system 100, a data retrieval/encryption system 110 (“data system”) and a print request system 120. Generally, remote print system 100 facilitates a secure printing operation by providing a user with information, e.g., an encryption key, that can be used to encrypt data. The user can then provide the information to data system 110, such as via print request system 120, so that data that is intended for printing at the remote location can be encrypted. Typically, such a data system is associated with the user's computer network and/or is otherwise associated with stored data that the user intends to print. By way of example, data system 110 can be associated with a server 115 of the computer network. Regardless of the particular configuration utilized, the information to be printed can be encrypted and transmitted to the remote print system. Thereafter, the information can be decrypted and printed.

As should be apparent, performing a print operation in the aforementioned manner can provide several advantages. For instance, once encrypted information is transmitted from the location at which it is stored, e.g., the user's computer network, the information can remain encrypted until it reaches the remote print system. Therefore, in embodiments of the remote print system implemented by printing devices, e.g., printer 130, information intended for printing by such a printer can remain encrypted until reaching the printer.

Additionally, the need for a target printing device to employ a complex front panel is potentially alleviated. More specifically, if the remote print system of a printing device did not generate the encryption and decryption keys, a user desiring to utilize that printing device may have to provide encryption and/or decryption keys to the remote print system. This could necessitate that the printing device be configured with one or more input devices, such as various input keys and/or a receiver, so that the encryption and/or decryption keys could be provided to the remote print system by the user.

As shown in FIG. 1, various devices can be used to implement secure printing system 10. For instance, portable computing devices, such as personal digital assistant (PDA) 140 and phone 150 can be used as will be described in greater detail herein. Communication of the various systems and/or devices of the secure printing system can be accomplished via a communication network 160. In this regard, network 160 may be any type of communication network employing any network topology, transmission medium, or network protocol. For example, network 160 may be any public or private packet-switched or other data network, including the Internet, circuit-switched networks, such as the public switched telephone network (PSTN), wireless network, or any other desired communications infrastructure and/or combination of infrastructures.

As mentioned before, remote print system 100 preferably is implemented by or otherwise associated with a printing device and can be implemented in software, firmware, hardware, or a combination thereof. When implemented in hardware, remote print system 100 can be implemented with any or a combination of various technologies. By way of example, the following technologies, which are each well known in the art, can be used: a discrete logic circuit(s) having logic gates for implementing logic functions upon data signals, an application specific integrated circuit (ASIC) having appropriate combinational logic gates, a programmable gate array(s) (PGA), and a field programmable gate array (FPGA).

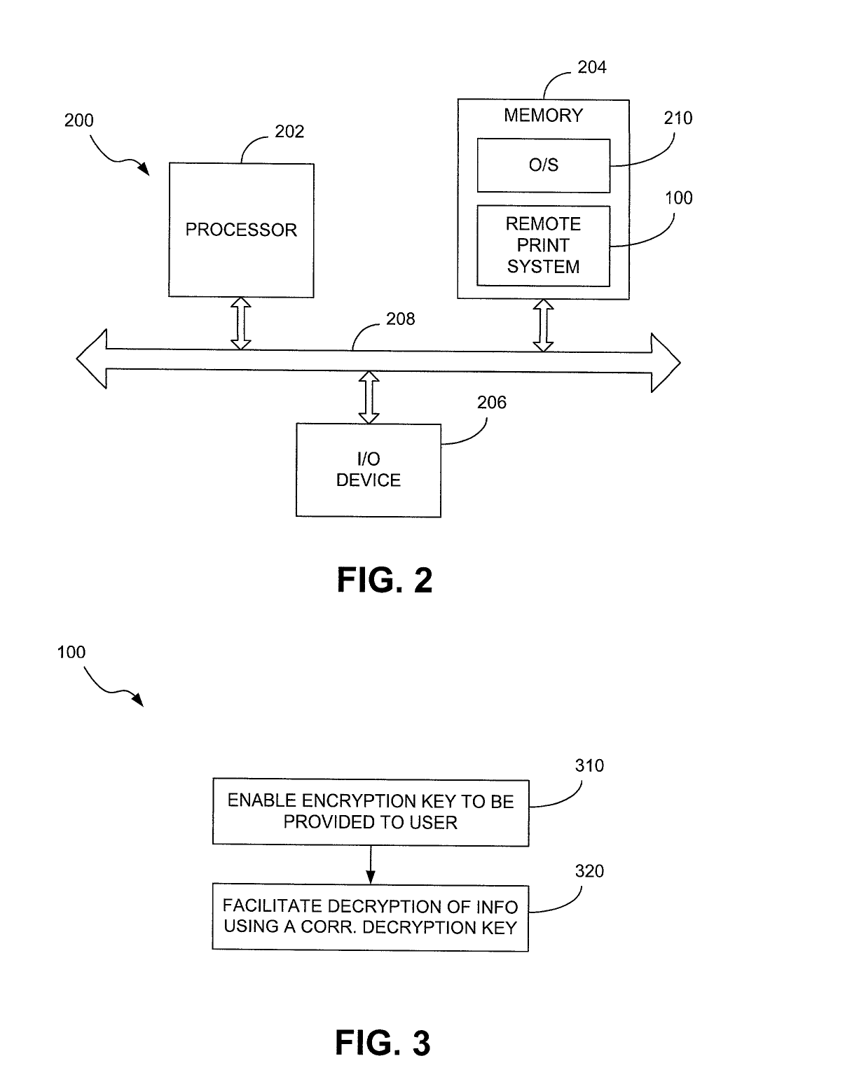

When implemented in software, remote print system 100 can be a program that is executable by a digital computer, e.g., a computer implemented as or associated with a printing device. An example of a printing device 200 that can implement remote print system 100 is shown schematically in FIG. 2.

Generally, in terms of hardware architecture, printing device 200, e.g., a laser printer, multi-function device, etc., includes a processor 202, memory 204, and one or more input and/or output (I/O) devices 206 (or peripherals) that are communicatively coupled via a local interface 208. Local interface 208 can be, for example, one or more buses or other wired or wireless connections, as is known in the art. Local interface 208 can include additional elements, which are omitted for ease of description. These additional elements can be controllers, buffers (caches), drivers, repeaters, and/or receivers, for example. Further, the local interface may include address, control, and/or data connections to enable appropriate communications among the components of printing device 200.

Processor 202 can be a hardware device configured to execute software that can be stored in memory 204. Processor 202 can be any custom made or commercially available processor, a central processing unit (CPU) or an auxiliary processor among several processors associated with the portable computing device 200. Additionally, the processor can be a semiconductor-based microprocessor (in the form of a microchip), for example.

Memory 204 can include any combination of volatile memory elements (e.g., random access memory (RAM, such as DRAM, SRAM, etc.)) and/or nonvolatile memory elements (e.g., ROM, hard drive, tape, CDROM, etc.). Moreover, memory 204 can incorporate electronic, magnetic, optical, and/or other types of storage media. Note that memory 204 can have a distributed architecture, where various components are situated remote from one another, but can be accessed by processor 202.

The software in memory 204 can include one or more separate programs, each of which comprises an ordered listing of executable instructions for implementing logical functions. The software in the memory 204 includes remote print system 100 and a suitable operating system (O/S) 210. The operating system 210 controls the execution of other computer programs, such as remote print system 100. Operating system 210 also provides scheduling, input-output control, file and data management, memory management, and communication control and related services.

The I/O device(s) 206 can include input devices such as a keypad and/or a receiver, for example. I/O device(s) 206 also can include output devices such as a display device and/or printing mechanism, for example. I/O device(s) 206 may further include devices that are configured to communicate both inputs and outputs such as a network communication port, for example.

When the printing device 200 is in operation, processor 202 is configured to execute software stored within the memory 204, communicate data to and from the memory 204, and generally control operations of the portable computing device 200. Remote print system 100 and the O/S 210, in whole or in part, are read by the processor 202, perhaps buffered within processor 202, and then executed.

When remote print system 100 is implemented in software, it should be noted that the remote print system can be stored on any computer readable medium for use by or in connection with any computer-related system or method. In the context of this document, a computer-readable medium is an electronic, magnetic, optical, or other physical device or means that can contain or store a computer program for use by or in connection with a computer-related system or method. Input system 110 can be embodied in any computer-readable medium for use by or in connection with an instruction execution system, apparatus, or device, such as a computer-based system, processor-containing system, or other system that can fetch the instructions from the instruction execution system, apparatus, or device and execute the instructions.

As used herein, a “computer-readable medium” can be any means that can store, communicate, propagate or transport a program for use by or in connection with an instruction execution system, apparatus, or device. Thus, a computer readable medium can be, for example but not limited to, an electronic, magnetic, optical, electromagnetic, infrared, or semiconductor system, apparatus, device, or propagation medium. More specific examples (a nonexhaustive list) of a computer-readable medium include the following: an electrical connection (electronic) having one or more wires, a portable computer diskette (magnetic), a random access memory (RAM) (electronic), a read-only memory (ROM) (electronic), an erasable programmable read-only memory (EPROM, EEPROM, or Flash memory) (electronic), an optical fiber (optical), and a portable compact disc read-only memory (CDROM) (optical). Note that the computer-readable medium could even be paper or another suitable medium upon which the program is printed, as the program could be electronically captured, via optical scanning of the paper or other medium, then compiled, interpreted or otherwise processed in a suitable manner, if necessary, and then stored in a computer memory.

Reference will now be made to the flowchart of FIG. 3, which depicts the functionality of a representative embodiment of remote print system 100. In this regard, each block of the flowchart represents a module segment or portion of code that comprises one or more executable instructions for implementing the specified logical function(s). It should also be noted that in some alternative implementations the functions noted in various blocks of FIG. 3, or any other of the accompanying flowcharts, may occur out of the order in which they are depicted. For example, two blocks shown in succession in FIG. 3 may, in fact, be executed substantially concurrently. In other embodiments, the blocks may sometimes be executed in the reverse order depending upon the functionality involved.

As shown in FIG. 3, the functionality of the representative embodiment of the remote print system or method 100 may be construed as beginning at block 310 where information is enabled to be provided to a user. Preferably, the information, e.g., an encryption key, is adapted to facilitate encrypting of information that the user intends to print. In block 320, decrypting of the information to be printed is facilitated.

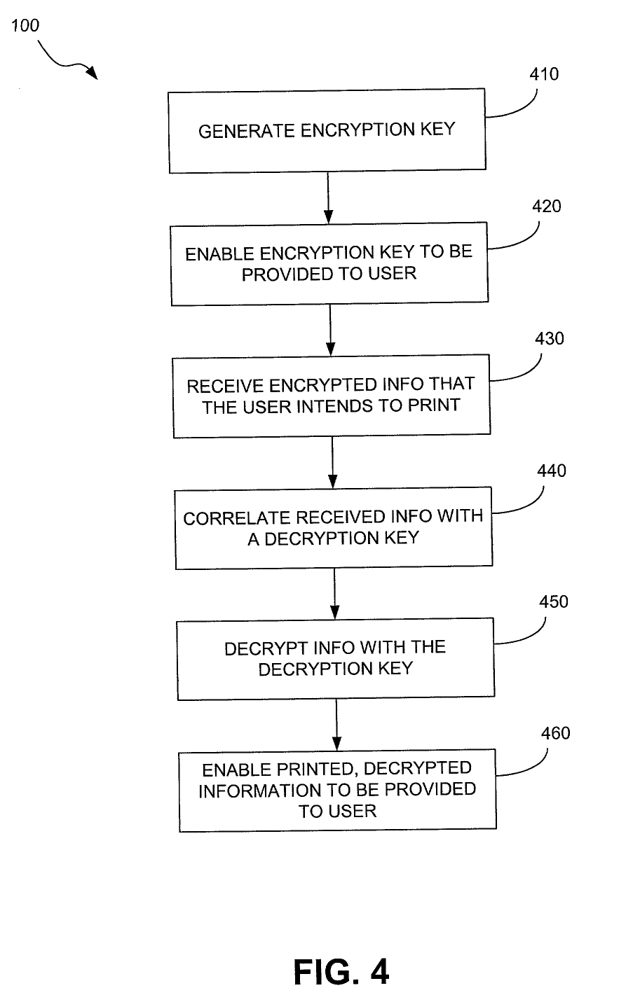

Functionality of an alternative embodiment of the remote print system or method 100 is depicted in the flow chart of FIG. 4. As shown in FIG. 4, system or method 100 may be construed as beginning at block 410 where information, e.g., an encryption key, for encrypting data is generated. For example, in some embodiments, such an encryption key could be selected from memory or otherwise generated by the remote print system. In block 420, such an encryption key is enabled to be provided to a user. For instance, the encryption key could be displayed to a user via a display device or communicated to the user via one of various communication protocols. Regardless of the particular methodology used to enable the encryption key to be provided to the user, upon receiving the encryption key, the user can then provide the encryption key so that information intended to be printed can be encrypted. In block 430, encrypted information, i.e., the information that is intended to be printed that was previously encrypted using the encryption key, is received. Thereafter, such as depicted in block 440, the received encrypted information is correlated with a decryption key. In some embodiments, such a decryption key can be generated when the corresponding encryption key is generated (block 410). Such a decryption key could be saved in memory until encrypted information corresponding to the relevant encryption key is received. Clearly, various other techniques can be used.

In block 450, the encrypted information is decrypted with the correlating decryption key. Thereafter, such as depicted in block 460, printed information corresponding to the received information is enabled to be provided to the user.

As should be evident from the flowchart of FIG. 4, once information that the user intends to be printed is encrypted, the information may remain in an encrypted format until being decrypted by the remote print system. Since the remote print system typically is associated with a printing device, i.e., the printing device that is to be used for printing the information, a high degree of security can be maintained.

As mentioned before, encrypted information that is intended by a user to be decrypted and then printed, can be provided to a remote print system in various manners. One such manner includes the use of a data retrieval/encryption system 110, such as that depicted in FIG. 1. In one embodiment, data system 110 is associated with the user's computer network, e.g., an office server.

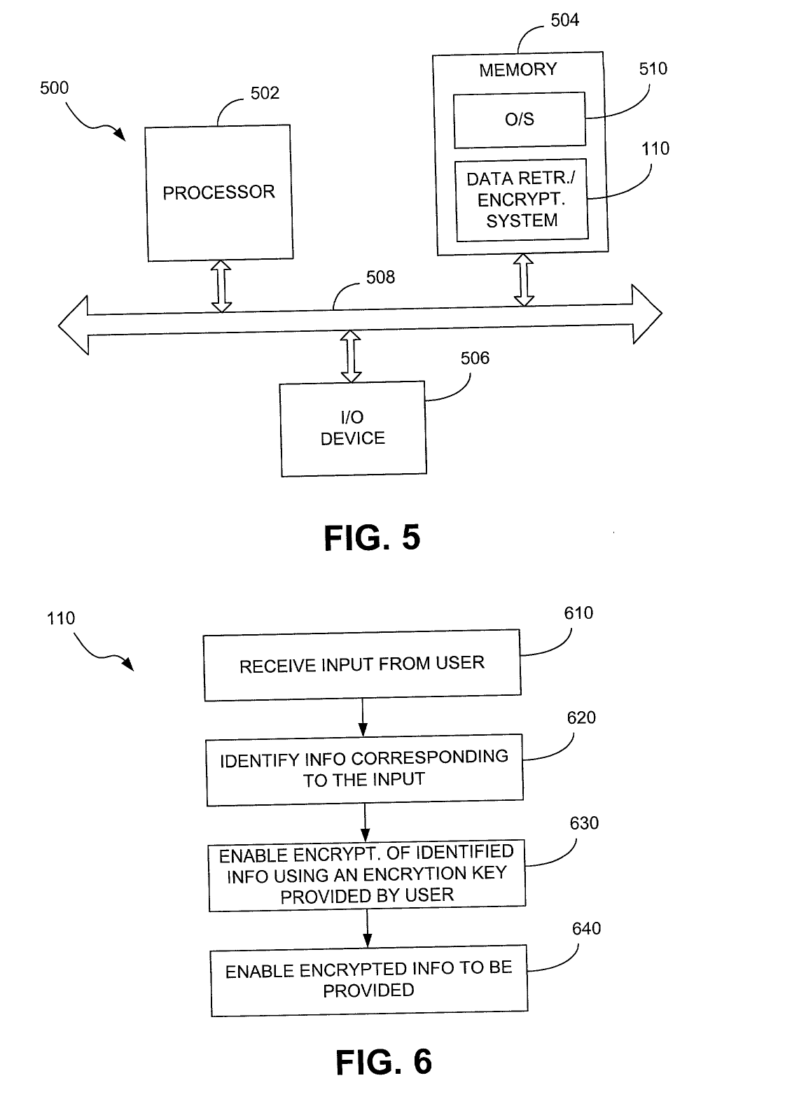

Much like the remote print system described before, data system 110 can be implemented in software, firmware, hardware, or a combination thereof. Preferably, data system 110 is implemented in software as an executable program. As such, data system 110 can be executed by a special or general purpose digital computer, such as a personal computer, work station, mini computer, or main frame computer. Typically, the data system is implemented by a server that is configured to receive inputs from and/or provide outputs to various devices, such as a personal digital assistant via a communication network. An example of a computer that can implement data system 110 is shown schematically in FIG. 5.

Generally, in terms of hardware architecture, computer 500 includes a processor 502, memory 504, and one or more input and/or output (I/)) devices 506 (or peripherals) that are communicatively coupled via a local interface 508. Software in memory 504 can include one or more separate programs, each of which comprises an ordered listing of executable instructions for implementing logical functions. In the embodiment of FIG. 5, the software in memory 504 includes data system 110 and a suitable operating system (O/S) 510.

The functionality of a representative embodiment of the data system 110 is depicted in the flowchart of FIG. 6. As shown in FIG. 6, data system or method 110 may be construed as beginning at block 610 where input from a user is received. In block 620, information corresponding to the user input is identified. By way of example, the information corresponding to the user input can be information that the user intends to be printed as well as an encryption key, i.e., an encryption key provided by the remote print system. Thereafter, such as depicted in block 630, the identified information is enabled to be encrypted and, in block 640, the encrypted information is enabled to be provided to a communication network. More specifically, the encrypted information preferably is directed to a remote print system corresponding to a location where the user intends to have the information printed.

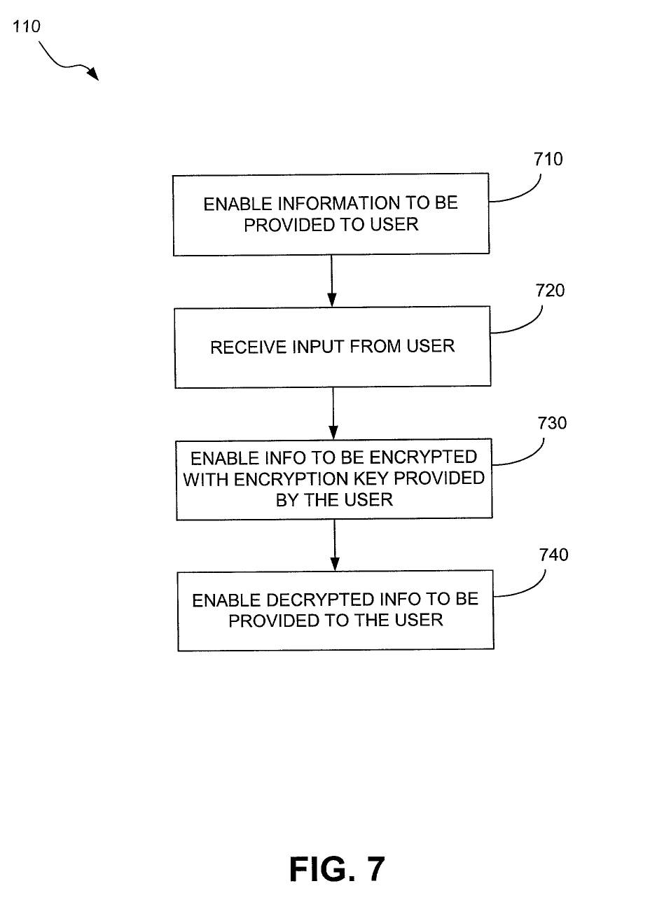

Functionality of an alternative embodiment of data system 110 is depicted in the flow chart of FIG. 7. As shown in FIG. 7, data system or method 110 may be construed as beginning at block 710 where information is enabled to be provided to a user. By way of example, the user could be notified that information, such an email message, is available for printing. This information could be provided to the user via a portable computing device, such as a personal digital assistant or phone with messaging capability. In block 720, input from the user is received. Continuing with the previous example, when the user has been informed that information is available for printing, the user may be queried as to whether the user desires to print the available information. If an affirmative response is received, such as via the input of block 720, the user may be requested to provide an encryption key. The encryption key can be used by the data system for encrypting the information prior to transmission. In other embodiments, such as described hereinbefore in relation to the flowchart of FIG. 6, the user could provide information to the data system that facilitates identification of information to be printed as well as an encryption key. In such an embodiment, the user may not receive a notification that information is available for printing.

In block 730, the information to be printed is enabled to be encrypted using the encryption key provided by the user. Thereafter, such as depicted in block 740, the encrypted information is enabled to be provided, such as by directing the encrypted information to a remote print system.

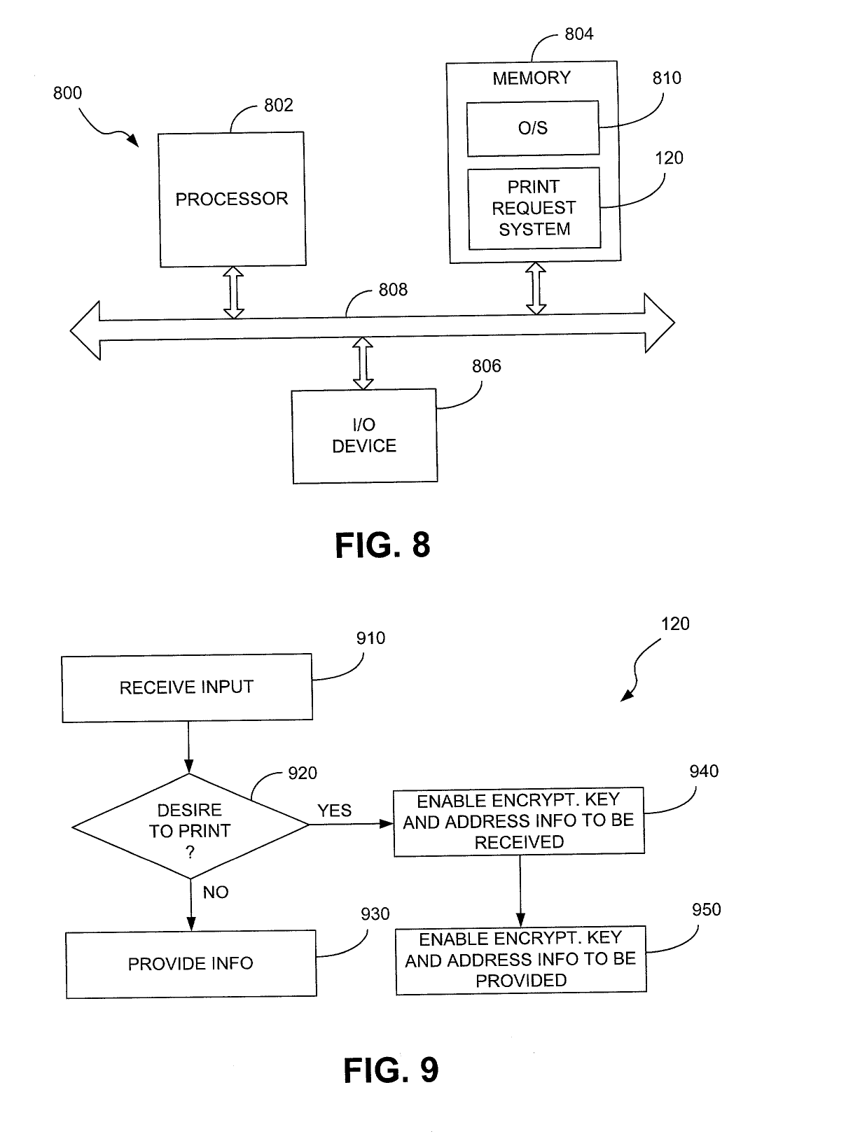

Based on the foregoing, it should be appreciated that embodiments of the data systems of the invention can be adapted to identify information to be printed in response to a user input. In some instances, the user input can be prompted by the data system, which notifies the user that information is available for printing. Typically, a graphical user interface provided by a portable computing device of the user can be used to facilitate such a notification. In embodiments where a user is only able to request printing of information after being prompted by the data system, a user's portable computing device may not need to be particularly configured, e.g., may not need to contain specific software, for interfacing with the data system. However, in those embodiments where a user is able to initiate the process of having information provided from a data system for printing, such a portable computing device may require particular adaptations. In particular, such a portable computing device may require the use of a print request system. A representative embodiment of a print request system 120 will now be described with reference to the schematic diagram of FIG. 8 and flowchart of FIG. 9.

Print request system 120 also can be implemented in software, firmware, hardware, or a combination thereof. Preferably, print request system 120 is implemented in software as an executable program. As such, print request system 120 can be executed by a special or general purpose digital computer, such as a personal digital assistant or other portable computing device. An example of a computer that can implement print request system 120 is shown schematically in FIG. 8.

Generally, in terms of hardware architecture, computer 800 includes a processor 802, memory 804, and one or more input and/or output (I/O) devices 806 (or peripherals) that are communicatively coupled via a local interface 808. Software in memory 804 can include one or more separate programs, each of which comprises an ordered listing of executable instructions for implementing logical functions. In the embodiment of FIG. 8, the software in memory 804 includes print request system 120 and a suitable operating system (O/S) 810.

The functionality of a representative embodiment of the print request system is depicted in the flowchart of FIG. 9. As shown in FIG. 9, print request system or method 120 may be construed as beginning at block 910 where an input is received. For instance, such an input may be provided from a user or, alternatively, from a data retrieval/encryption system. In block 920, a determination is made as to whether the user intends to print information corresponding to the input. If it is determined that the user does not desire to print the information, the information may be provided to the user. By way of example, the information may be displayed to the user via a display device of the portable computing device (depicted in block 930). If however, it is determined that the user intends to print the information, the process may proceed to block 940.

In block 940, encryption key and address information corresponding to a remote print system is enabled to be received. This information could be manually provided to the print request system via an input device of the portable computing device. Thereafter, such as depicted in block 950, the encryption key and address information is enabled to be provided to the data system.

The foregoing description has been presented for purposes of illustration and description. It is not intended to be exhaustive or to limit the invention to the precise forms disclosed. Modifications or variations are possible in light of the above teachings. The embodiment or embodiments discussed, however, were chosen and described to provide the best illustration of the principles of the invention and its practical application to thereby enable one of ordinary skill in the art to utilize the invention in various embodiments and with various modifications as are suited to the particular use contemplated. All such modifications and variations, are within the scope of the invention as determined by the appended claims.

1. A secure printing system comprising:
a remote print system configured to provide a user with an encryption key, receive information encrypted using the encryption key, decrypt the information with a corresponding decryption key, and enable the information, once decrypted, to be printed.

2. The secure printing system of claim 1, wherein said remote print system generates the encryption key and the corresponding decryption key.

3. The secure printing system of claim 1, further comprising:
a printing device configured to print hardcopy of the information; and
wherein said remote print system is implemented by the printing device.

4. The secure printing system of claim 3, wherein said printing device includes a display device; and
wherein the encryption key is displayed to the user via the display device.

5. The secure printing system of claim 1, wherein the remote print system has a an address usable for providing information to the remote print system via a communication network; and
wherein the remote print system is configured to provide the user with the address.

6. The secure printing system of claim 1, further comprising:
a data retrieval/encryption system arranged at a location remote from the remote print system, the data retrieval/encryption system being configured to communicate with the remote print system via a communication network, the data retrieval/encryption system being further configured to receive the encryption key and information corresponding to information that the user intends to print such that the data retrieval/encryption system locates the information that the user intends to print, encrypts the information that the user intends to print using the encryption key, and communicates the information in an encrypted form to the remote print system.

7. The secure printing system of claim 6, wherein the data retrieval/encryption system is configured to communicate to the user, via the communication network, that information is available for printing such that, if the user desires the information to be printed, the user can obtain an encryption key from the remote print system and communicate the encryption key to the data retrieval/encryption system for use in encrypting the information to be printed.

8. The secure printing system of claim 1, further comprising:
a print request system communicating with the data retrieval/encryption system, the print request system being configured to receive the encryption key and information corresponding to information that the user intends to print such that the print request system communicates the encryption key and the information corresponding to information that the user intends to print to the data retrieval/encryption system.

9. The secure printing system of claim 8, wherein the print request system is implemented by a portable computing device.

10. The secure printing system of claim 9, wherein the portable computing device communicates with the data retrieval/encryption system via wireless communication.

11. A secure printing system for printing information, the information being stored in memory at a location remote from a user, the information being accessible to the user via a communication network, said secure printing system comprising:
a remote print system arranged at a location remote from the information and configured to provide a user with an encryption key,
said remote print system being configured to communicate with the communication network such that said remote print system receives information encrypted using said encryption key,
said remote print system being further configured to decrypt said information with a corresponding decryption key, and enable said information, once decrypted, to be printed.

12. The secure printing system of claim 11, further comprising:
means for providing the user with said encryption key.

13. The secure printing system of claim 12, wherein said means for providing the user with said encryption key is a display device.

14. The secure printing system of claim 11, further comprising:
a printing device configured to print hardcopy of said information; and
wherein said remote print system is implemented by said printing device such that, once said information is decrypted using said decryption key, said printing device is enabled to print said information as hardcopy.

15. A method for secure printing of information transmitted via a communication network, the information being stored in memory at a first location remote from a user, the information being accessible to the user via the communication network, said method comprising:
providing the user with an encryption key;
receiving, at a second location remote from the first location, information encrypted using the encryption key via the communication network;
decrypting the information with a corresponding decryption key; and
enabling the information, once decrypted, to be printed.

16. The method of claim 15, further comprising:
providing the user with an address usable for providing information to the second location via the communication network.

17. The method of claim 15, wherein the encryption key is provided to the user visually.

18. A method for secure printing of information transmitted via a communication network, the information being stored in memory at a first location remote from a user, the information being accessible to the user via the communication network, said method comprising:
enabling an encryption key to be received at a second location remote from the first location;
enabling information that is to be printed to be identified; and
enabling the encryption key and information corresponding to the information that is to be printed to be transmitted to the first location via the communication network such that the information that is to be printed is encrypted using the encryption key, transmitted to the second location via the communication network, decrypted using a corresponding decryption key, and printed.

19. The method of claim 18, wherein enabling the encryption key and information corresponding to the information that is to be printed to be transmitted comprises:
enabling the encryption key and information corresponding to the information that is to be printed to be transmitted via wireless communication.

20. The method of claim 18, wherein enabling an encryption key to be received at a second location remote from the first location comprises:
enabling the user to provide the encryption key.
